(19) United States
(12) Patent Application Publication
(10) Pub. No.: US 2026/0067403 A1
(43) Pub. Date: Mar. 5, 2026

(54) Providing Telephony Services By Call Forwarding At A Telephony Server

(71) Applicant: Zoom Communications, Inc., San Jose, CA (US)

(72) Inventors: Kevin Huang, New York, NY (US); George John Thomas, Pleasanton, CA (US); Yu Xie, Hefei (CN); Haibing Xu, San Jose, CA (US); Tongqing Yu, Hefei (CN); Yong Zhang, San Jose, CA (US)

(21) Appl. No.: 18/824,272

(22) Filed: Sep. 4, 2024

(51) Int. Cl. H04M 3/523; H04M 3/493

(52) U.S. Cl. CPC H04M 3/5232; H04M 3/493

(57) ABSTRACT

A telephony server providing telephony services to a destination telephony address receives an initiation request for a telephone call from an external telephony device to the destination telephony address. The telephony server determines, based on a stored setting associated with the destination telephony address, whether call forwarding is enabled by the destination telephony address. Based on determining that the call forwarding is not enabled, the telephony server provides telephony services for the telephone call by the telephony server. Based on determining that the call forwarding is enabled, the telephony server connects the external telephony device to a session border controller associated with the call forwarding. The session border controller provides the telephony services for the telephone call.

### FIELD

This disclosure generally relates to providing telephony services, and, more specifically, to providing telephony services at an on-premises telephony node.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 is a block diagram of an example of a communications system for providing telephony services.

FIG. 6 is a data flow diagram of connecting a caller device to internal telephony devices using a network-based session border controller.

FIG. 7 is a data flow diagram of connecting a caller device to internal telephony devices using a telephony server.

FIG. 8 illustrates a graphical user interface for creating or editing a survivable distribution group.

FIG. 9 is a flowchart of an example of a technique for providing telephony services at an on-premises telephony node.

FIG. 10 is a flowchart of an example of a technique for routing to a survivable distribution group.

FIG. 11 is a flowchart of an example of a technique for providing telephony services using a telephony server or an on-premises session border controller.

### DETAILED DESCRIPTION

A Unified Communications as a Service (UCaaS) platform integrates various communication modalities to provide users with a seamless and cohesive communication experience. Among these modalities, telephony services are implemented as a core component, enabling users to make and receive voice calls directly through the UCaaS platform. The integration of telephony into the UCaaS environment allows for enhanced accessibility and functionality, where voice communication is fully interoperable with other communication channels such as video conferencing, instant messaging, and email. This capability ensures that users can manage all forms of communication within a single, unified interface, thereby improving efficiency and user experience.

Telephony service providers compete with one another by providing advanced telephony services using software or hardware residing at a cloud-based telephony server. Examples of these telephony services may include at least one of an automated receptionist service, a call queue (CQ) service, or a shared line group (SLG) service. The automated receptionist service may include, in response to an incoming telephone call, playing a greeting and providing a menu (e.g., an interactive voice response (IVR) menu) for routing the incoming call to a user-selected destination. The CQ service may include serially routing an incoming call to multiple users according to a stored call queue data structure. For example, if a call is directed to a sales department of a car dealership, a first person's telephone rings, then a second person's telephone rings if the first person does not answer, then a third person's telephone rings if the second person does not answer. The SLG service may include allowing access to a telephone line from multiple computing devices associated with multiple user accounts, where an incoming call to a telephone number of the shared line group causes parallel or simultaneous ringing of the multiple computing devices. Referring to the same example, if a call is directed to a sales department of a car dealership, the first, second, and third persons' telephones ring in parallel allowing any one of them to answer. In some circumstances, the cloud-based telephony server may have an outage. An outage of cloud-based telephony services may thus limit or entirely prevent the users thereof from accessing or otherwise using those telephony services. Techniques for providing survivable telephony services such as automated receptionist, CQ, or SLG during (e.g., in the event of) an outage of the cloud-based telephony server may thus be desirable. As used herein, the term “survivable,” may include, among other things, a telephony service that is able to be provided during an outage of the cloud-based telephony server or at times when a network connection between the premises and the cloud-based telephony server is operating below threshold conditions (e.g., in terms of at least one of download speed, upload speed, ping time, or latency). For example, automated receptionist service, CQ service, or SLG service may be survivable if they are capable of being provided (e.g., using on-premises hardware or on-premises software) during the outage of the cloud-based telephony server or at times when the network connection between the premises and the cloud-based telephony server is operating below the threshold conditions.

Implementations of this disclosure address problems such as these using an on-premises telephony node, residing on the premises of a customer of a telephony service provider, that is capable of providing the advanced telephony services. Under typical circumstances, when the telephony server is (and thus cloud-based telephony services are) available, the telephony server provides the telephony services. However, when there is an outage of the telephony server (or a connection between the telephony server and the premises, such as an outage of Internet services on the premises), the on-premises telephony node provides the telephony services in place of the telephony server. In some cases, it may be advantageous to use the on-premises telephony node in place of routing to another telephony server. For example, when there is an outage of Internet services on the premises, routing to another telephony server may not be practical.

Some implementations relate to configuring the on-premises telephony node to provide the telephony services. In some cases, the on-premises telephony node obtains, from the telephony server, stored data (e.g., a configuration file) associated with the provision of a telephony service. The telephony node may periodically obtain updates to the stored data from the telephony server to ensure that the telephony node has the latest version of the stored data. Upon occurrence of an outage of the telephony server, the on-premises telephony node receives (e.g., from an administrator device) an indication that the telephony server is unable to provide the telephony service. The on-premises telephony node then provides the telephony service using the stored data.

Some implementations relate to routing to a survivable distribution group (SDG). In some examples, the SDG corresponds to a CQ or a SLG. A session border controller (SBC) that is separate from a telephony server associated with a destination telephony address receives an initiation request for a telephone call from an originating telephony device to the destination telephony address. The destination telephony address is an address of the SDG. The SBC attempts to connect the originating telephony device to the telephony server. Upon failing to connect the originating telephony device to the telephony server, the SBC connects the originating telephony device to a backup address associated with the SDG. The SBC causes connection of the telephony device to a device of the SDG via the backup address.

Some implementations relate to the telephony server being associated with the carrier or a provider exchange (PEX) system where the telephony server is integrated with the carrier. The telephony server, which provides telephony services to a destination telephony address, receives an initiation request for a telephone call from an external telephony device (e.g., a telephone connected to the public switched telephone network (PSTN)) to the destination telephony address. The telephony server determines whether call forwarding is enabled by the destination telephony address. If the call forwarding is not enabled, the telephony server provides the telephony services for the telephone call. If the call forwarding is enabled, the telephony server connects the external telephony device to a SBC associated with the call forwarding. The SBC provides the telephony services for the telephone call. The SBC may be associated with the telephony node.

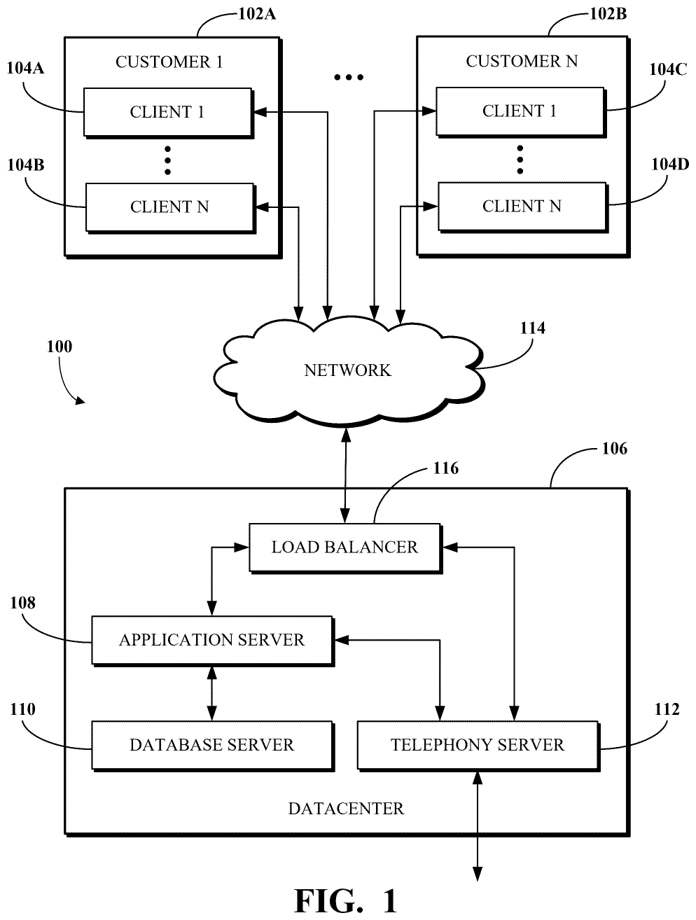

To describe some implementations in greater detail, reference is first made to examples of hardware and software structures used to implement a system for providing telephony services using on-premises software or hardware. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a PSTN system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

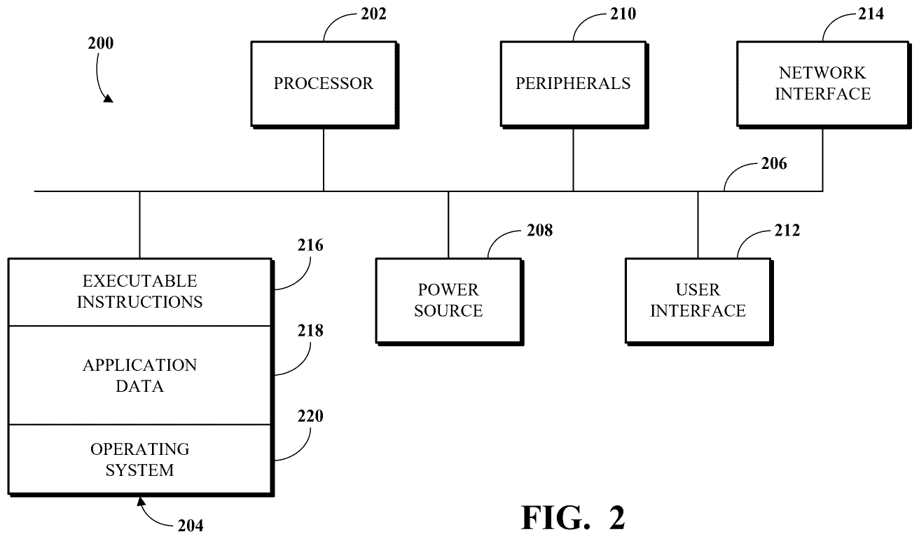

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

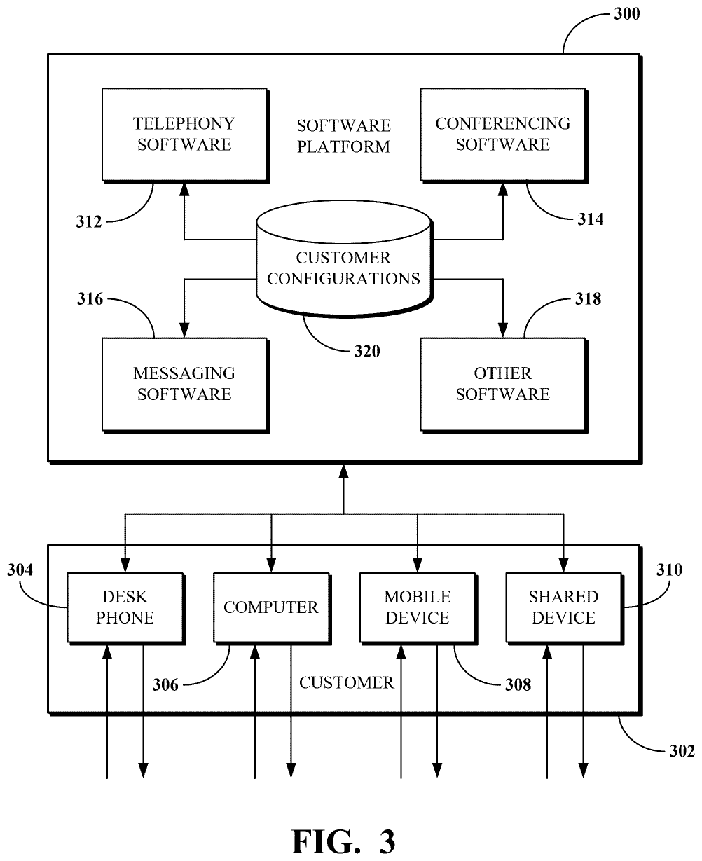

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software for facilitating the use of an on-premises telephony node for providing telephony services. In some such cases, the telephony software 312 may include the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

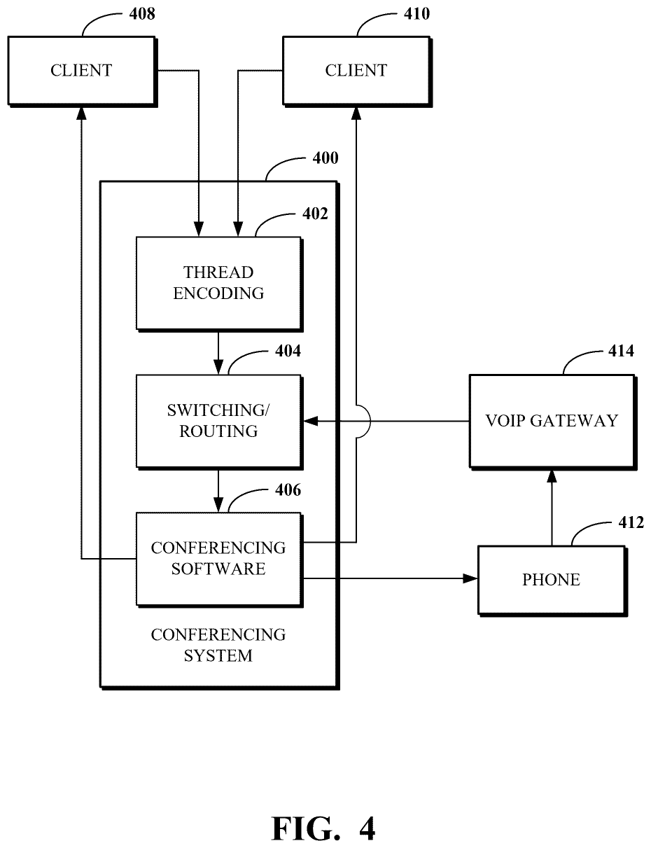

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may, for example, the conferencing software 314 shown in FIG. 3, is software for implementing conferences (e.g., video conferences) between users of clients and/or phones, such as clients 408 and 410 and phone 412. For example, the clients 408 or 410 may each be one of the clients 304 through 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other numbers of clients and/or other numbers of phones can connect to the conferencing system 400.

Implementing a conference includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A user interface tile as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may be one of a gallery view in which all user interface tiles are similarly or identically sized and arranged in a generally grid layout or a speaker view in which one or more user interface tiles for active speakers are enlarged and arranged in a center position of the conferencing software user interface while the user interface tiles for other conference participants are reduced in size and arranged near an edge of the conferencing software user interface. In some cases, the view style or one or more other configurations related to the display of user interface tiles may be based on a type of video conference implemented using the conferencing software 406 (e.g., a participant-to-participant video conference, a contact center engagement video conference, or an online learning video conference, as will be described below).

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant access the conferencing software 406 from a phone, such as the phone 412, the user interface tile for the participant may be limited to a static image showing text (e.g., a name, telephone number, or other identifier associated with the participant or the phone 412) or other default background aspect since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90p, 180p, 360p, 720p, and/or 1080p, amongst others. The video streams may be received from the clients over a network, for example, the network 114 shown in FIG. 1, or by a direct wired connection, such as using a universal serial bus (USB) connection or like coupling aspect. After the video streams are encoded, the switching/routing tool 404 direct the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining using clients turns on their video stream for any portion of the conference. In some cases, however, the conference may have video disabled, such as where each participant connects to the conference using a phone rather than a client, or where a host of the conference selectively configures the conference to exclude video functionality.

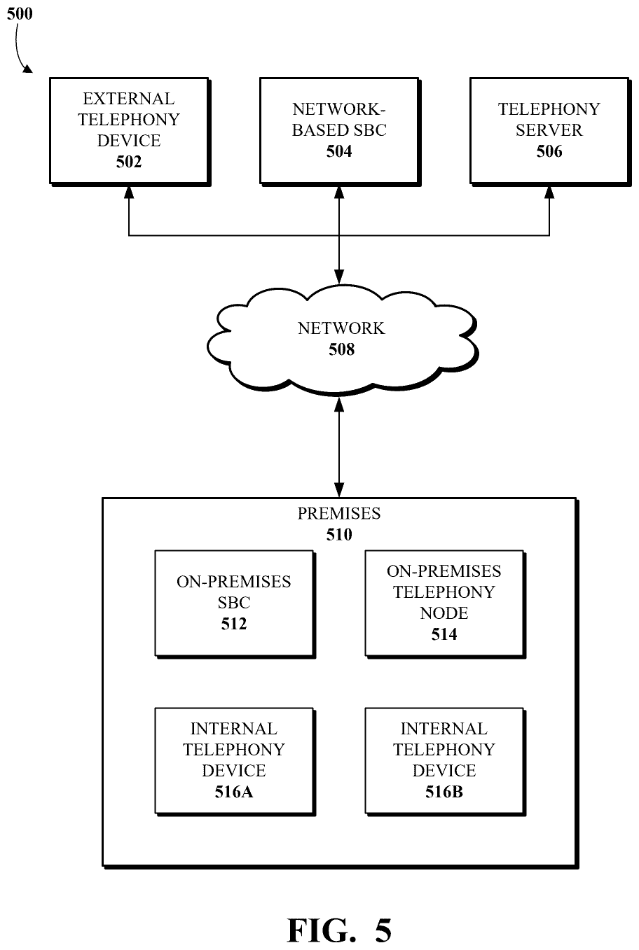

FIG. 5 is a block diagram of an example of a communication system 500 for providing telephony services. As shown, the system 500 includes an external telephony device 502, a network-based SBC 504, and a telephony server 506 connected to one another via a network 508. The network 508 also connects to a premises 510. The premises 510 includes an on-premises SBC 512, an on-premises telephony node 514, and internal telephony devices 516A-B. The premises 510 may be operated by one of the customers 102A-B and may correspond to a physical space occupied by that one of the customers 102A-B.

The external telephony device 502 may include at least one of a telephone connected to the PSTN, a VOIP telephone, a mobile phone, a softphone, or a computer running telephone communication software. The external telephony device 502 is located outside of the premises 510. However, in some implementations, the external telephony device 502 may be a telephony device located on the premises 510.

The network-based SBC 504 is a network element used in VOIP communications to manage and control the signaling and media streams involved in setting up, conducting, and tearing down calls or sessions. Positioned at the border between two networks, typically between an enterprise network and a service provider network, the network-based SBC 504 ensures secure and reliable communication by enforcing policies related to security, quality of service (QoS), and interworking. The network-based SBC 504 acts as a gatekeeper, performing functions such as protocol translation, media transcoding, and network address translation (NAT) traversal, thereby allowing different networks and devices to communicate seamlessly.

The network-based SBC 504 operates by monitoring and controlling the flow of data packets that carry voice, video, and other forms of real-time communications. It provides protection against security threats, such as denial-of-service (DoS) attacks, by filtering and blocking malicious traffic. Additionally, the network-based SBC 504 manages bandwidth allocation to ensure high-quality communication. The network-based SBC 504 can prioritize certain types of traffic based on predefined rules. By enforcing these policies and providing interworking capabilities, the network-based SBC 504 plays a role in maintaining the integrity and quality of VOIP communications across different networks.

In some implementations, for example in bring your own carrier (BYOC) implementations of the disclosed technology, the network-based SBC 504 is used, and the network-based SBC is operated by the carrier associated with the premises 510. In some implementations, for example in implementations related to the telephony server 506 being associated with the carrier or a PEX system where the telephony server 506 is integrated with the carrier, the SBC functionality is performed by the on-premises SBC 512, and the disclosed technology may be implemented without the network-based SBC 504.

The telephony server 506 manages and routes voice calls via the network 508. The telephony server 506 interfaces with various telephony devices, such as the external telephony device 502 or the internal telephony devices 516A-B, to establish, maintain, and terminate voice sessions. The telephony server 506 handles tasks including call signaling, call routing, user authentication, and feature execution, including voicemail, conferencing, and call forwarding. By integrating with other network components, the telephony server 506 facilitates the flow of voice communication across the network 508.

One distinction between the telephony server 506 and the network-based SBC 504 lies in their functions within the communication system 500. While the telephony server 506 focuses on the management and control of call signaling and user services within an internal network, the network-based SBC 504 operates at the network's boundary, managing and securing the flow of communication between different networks. The network-based SBC 506 ensures security, interoperability, and quality of service across network borders, whereas the telephony server 506 handles the internal processing and routing of calls. In summary, the telephony server 506 manages the “brains” of the communication system 500, while the network-based SBC 506 safeguards and facilitates the “gateway” through which communications pass between distinct networks of the network 508.

The network 508 may include at least one of an internal telephone network, an external telephone network, the PSTN, a VOIP network, or a cellular network. The network 508 may include any network over which voice or video calling technology may travel.

The premise 510 may include one or more physical premises or regions. For example, the premises 510 may include one or more of an office, a residence, an office building, a residential building, or a university campus. The on-premises SBC 512 performs functionality similar to that of the network-based SBC 504, but is located on the premises 510. The on-premises telephony node 514 performs functionality similar to that of the telephony server 506, but is located on the premises 510. Each of the internal telephony devices 516A-B may include at least one of a VOIP telephone, a mobile phone, a softphone, or a computer running telephone communication software. While two internal telephony devices 516A-B are illustrated, the disclosed technology may be implemented with other numbers of internal telephony devices.

According to some implementations, to implement telephony services such as an automated receptionist service, a CQ service, or a SLG service, the telephony server 506 stores data (e.g., a configuration file or other configuration data) associated with the telephony service. For example, for the automated receptionist service, the telephony server 506 may store an IVR menu to be presented to the external telephony device 502 upon initiating a call. For the CQ service or the SLG service, the telephony server 506 stores, within the stored data, a distribution group (DG) of devices or addresses that are to ring in response to the initiation of a call (e.g., from the external telephony device 502). The DG may be called a survivable distribution group (SDG) if the on-premises SBC 512 and/or the on-premises telephony node 514 are configured to handle the DG service (e.g., the CQ service or the SLG service) when the telephony server 506 is unavailable, for example, using the techniques described herein.

The stored data may be a configuration file or another data structure. For the CQ service, the stored data may include a CQ data structure indicating the devices, addresses, or telephone numbers to ring and the order in which they should ring. For the SLG service, the stored data may include a list (or other data structure) of the devices, addresses, or telephone numbers to ring simultaneously or in parallel upon receiving a telephone call at a telephony address associated with the SLG. For the automated receptionist service, the stored data may include a recording of the greeting to play and a recording of menu prompts (e.g., for an IVR menu or another type of menu).

The on-premises telephony node 514 obtains the stored data associated with the telephony services. For example, the on-premises telephony node 514 may prompt, at a predefined interval (e.g., once per hour or once per day) the telephony server 506 to transmit updates to the stored data to the on-premises telephony node 514. In response to the prompt, the on-premises telephony node 514 receives the updates to the stored data.

After receiving the stored data and, in some cases, updates to the stored data, the on-premises telephony node 514 receives an indication that the telephony server 506 is unable to provide the telephony service. This may occur, for example, due to a failure of a network connection between the premises 510 and the telephony server 506, or due to the network connection having a download speed below a download threshold or an upload speed below an upload threshold. In some cases, an administrator provides, via an administrator device, a notification to the on-premises telephony node 514 that the network connection has failed. Alternatively, the on-premises telephony node 514 may detect that the network connection has failed by periodically measuring the download speed or the upload speed.

Upon receiving the indication that the telephony server 506 is unable to provide the telephony service, the on-premises telephony node 514 provides the telephony service based on the stored data. The on-premises telephony node 514 may read the stored data and configure the telephony services, on the premises 510, based on the stored data. For example, the on-premises telephony node 514 may configure, based on the stored data, at least one of the automated receptionist service, the CQ service, or the SLG service.

As a result of some implementations, telephony services at the premises 510 are survivable and are capable of being implemented when devices of the premises 510 are unable to connect to the telephony server 506. In some cases, it may be desirable for conferencing services to be survivable when devices of a premises that implements conferencing services (e.g., using UCaaS technology) are unable to connect to a conferencing server. Some implementations of the disclosed technology are directed to providing survivable conferencing services.

In addition to providing telephony services during an outage, the disclosed technique could be used to the provision of conferencing services during a network outage by integrating conferencing data into the stored data obtained by the on-premises telephony node (or by using an on-premises conferencing node that is in the same machine or a different machine from the on-premises telephony node). This conferencing data could include, for example, information such as participant lists, schedules of audio conferences or video conferences, access credentials, and any pre-established audio or video settings. When the on-premises telephony node (or the on-premises conferencing node) detects that the telephony server (or a conferencing server such as a server of the conferencing system 400) is unable to provide network-based conferencing services, it could utilize the stored conferencing data to establish and manage conferences locally, thereby ensuring the continuity of conferencing services despite the network outage.

In addition, the on-premises telephony node could be configured to handle dynamic changes in conferencing needs during the outage. For example, the node could allow users to initiate new conference calls, add or remove participants, or modify existing conference settings. This could be achieved by storing additional logic and resources within the node that would typically be handled by the telephony server in a network-based environment. By doing so, the system would be able to maintain the full functionality of the conferencing services, ensuring minimal disruption to business operations during the outage.

Moreover, the disclosed technique could be further enhanced by enabling the on-premises telephony node to synchronize any changes made during the outage with the telephony server once network connectivity is restored. This synchronization would involve updating the server with any modifications to conference calls, participant lists, or other relevant data that occurred during the outage. As a result, the network-based telephony service would resume seamlessly, with no loss of information or functionality, thereby providing a robust and resilient conferencing solution.

According to some implementations, and on-premises conferencing node obtains stored data associated with a network-based conferencing service from a conferencing server. The on-premises conferencing node receives, an indication that the conferencing server is unable to provide the network-based conferencing service. The on-premises conferencing node provides, in response to the indication, the network-based conferencing service based on the stored data.

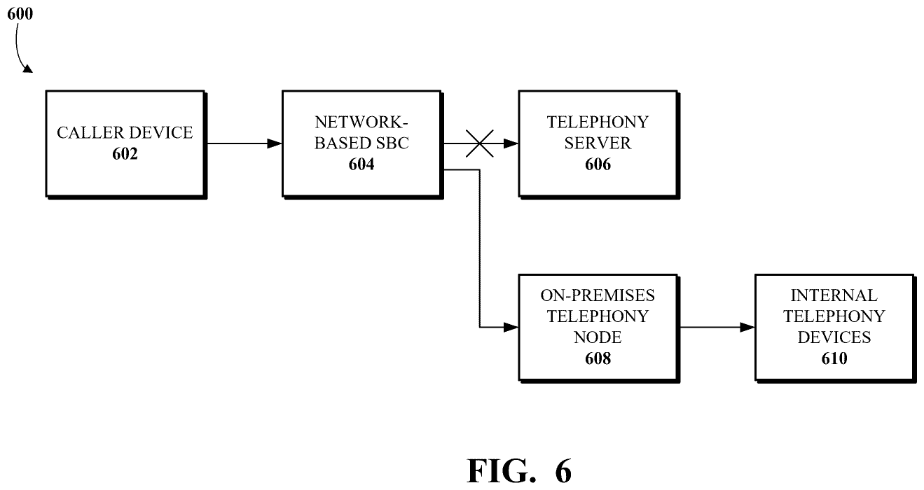

FIG. 6 is a data flow diagram 600 of connecting a caller device to internal telephony devices using a network-based SBC. The data flow diagram 600 may be associated with BYOC-related implementations, where the telephony carrier associated with the network-based SBC is associated with an entity that is different from an entity providing advanced telephony services, such as automated receptionist, CQ, or SLG.

As shown, the data flow diagram 600 includes a caller device 602, a network-based SBC 604, a telephony server 606, an on-premises telephony node 608, and internal telephony devices 610. The caller device 602 may be an external (to the premises of the on-premises telephony node 608 and the internal telephony device 610) device that is connected to at least one of the PSTN, a VOIP network, or a cellular network. The caller device 602 may correspond to the external telephony device 502. The network-based SBC 604 may be an SBC of a telephony carrier associated with the premises. The network-based SBC 604 may correspond to the network-based SBC 504.

Upon receiving an inbound (to the premises) telephone call from the caller device 602, the network-based SBC 604 attempts to forward the inbound telephone call to the telephony server 606. The telephony server 606 may correspond to the telephony server 506. As illustrated, the telephony server 606 is unavailable for processing telephone calls (as indicated by the cross over the line from the network-based SBC 604 to the telephony server 606). Upon failing to connect the caller device 602 to the telephony server 606, the network-based SBC 604 connects the caller device 602 to the on-premises telephony node 608 based on an address of the on-premises telephony node 608 stored at the network-based SBC 604 or in a data repository accessed by the SBC 604. The network-based SBC 604 then causes, via the on-premises telephony node 608, connection of the caller device 602 to one or more of the internal telephony devices 610, as specified in a distribution group (e.g., a survivable distribution group) identified based on metadata of the inbound telephone call from the caller device 602. The internal telephony devices 610 may correspond to the internal telephony devices 516A-B. The internal telephony devices 610 for the call may be identified based on a CQ or a SLG of the telephony address. The internal telephony device 610 may be selected, by a user of the caller device 602, via an automated receptionist service implemented by the on-premises telephony node 608. The automated receptionist may provide an IVR menu or another type of menu.

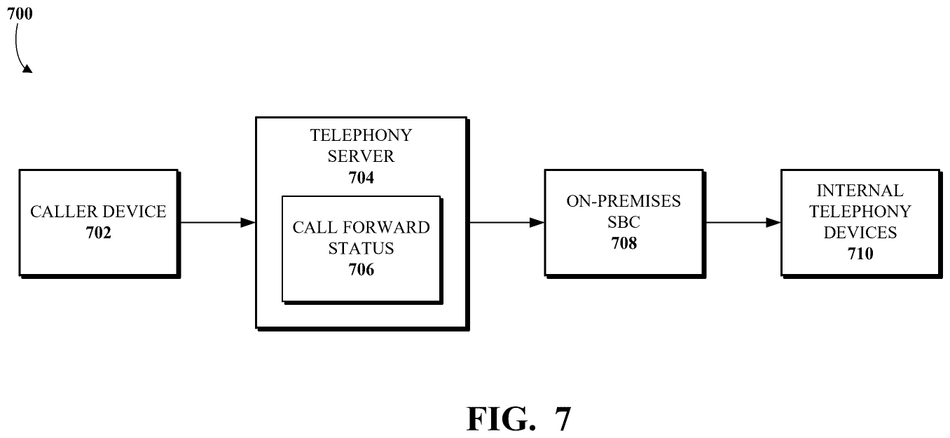

FIG. 7 is a data flow diagram 700 of connecting a caller device to internal telephony devices using a telephony server. The data flow diagram 700 may be associated with native or PEX-related implementations, where the telephony carrier associated with the premises is also associated with the telephony server. The carrier may be responsible for providing the advanced telephony services, such as automated receptionist, CQ, or SLG.

As shown, the data flow diagram 700 includes a caller device 702. The caller device 702 may correspond to the external telephony device 502. The data flow diagram 700 includes a telephony server 704 that stores a call forward status 706 for a telephony address managed by the telephony server 704. In some cases, the telephony server 704 stores multiple call forward statuses for multiple telephony addresses managed by the telephony server 704. The telephony server 704 may correspond to the telephony server 506.

The data flow diagram 700 includes an on-premises SBC 708. The on-premises SBC 708 may correspond to the on-premises SBC 512. The on-premises SBC 708 performs the functions of an SBC (e.g., the network-based SBC 504) but is located on the premises (e.g., the premises 510) with the internal telephony devices 710 and supports communication with the on-premises devices 710 and telephony addresses associated with the premises.

As illustrated in FIG. 7, the caller device 702, upon initiating a telephone call to a telephony address associated with the premises, connects to the telephony server 704. The telephony server determines a call forward status 706 of the telephony address. If the call forward status corresponds to call forward being disabled, the telephony services are provided by the telephony server 704 and/or the telephony server 704 directly connects the call to the internal telephony devices 710. In some cases, during a telephony outage, an administrator uses an administrator device connected to the telephony server 704 to enable call forwarding to the on-premises SBC 708. If the call forward status 706 corresponds to call forwarding to the on-premises SBC 708, the call is forwarded to the on-premises SBC 708. The on-premises SBC 708 provides the telephony services, which may include connecting the call to one or more of the internal telephony devices 710.

According to some implementations, the telephony server 704 receives an initiation request for a telephone call from the caller device 702 to the telephony address. The telephony server 704 determines, based on the call forward status 706 of the telephony address stored at the telephony server 704, whether call forwarding is enabled by the telephony address. Based on determining that call forwarding is not enabled, the telephony server 704 provides the telephony services for the telephone call. Based on determining that call forwarding is enabled, the telephony server 704 connects the caller device 702 to the on-premises SBC 708 associated with the call forwarding. For example, the call forwarding status 706 may specify a telephony address of the on-premises SBC 708. The on-premises SBC 708 then provides the telephony services for the telephone call.

As a result of the implementation of the techniques of FIG. 6 and/or FIG. 7, the telephony services are survivable. In other words, telephony services may be implemented when devices of a premises (e.g., the premises 510) are incapable of connecting to a telephony server (e.g., the telephony server 506) or the connection between the telephony server and the premises has latency exceeding a latency threshold.

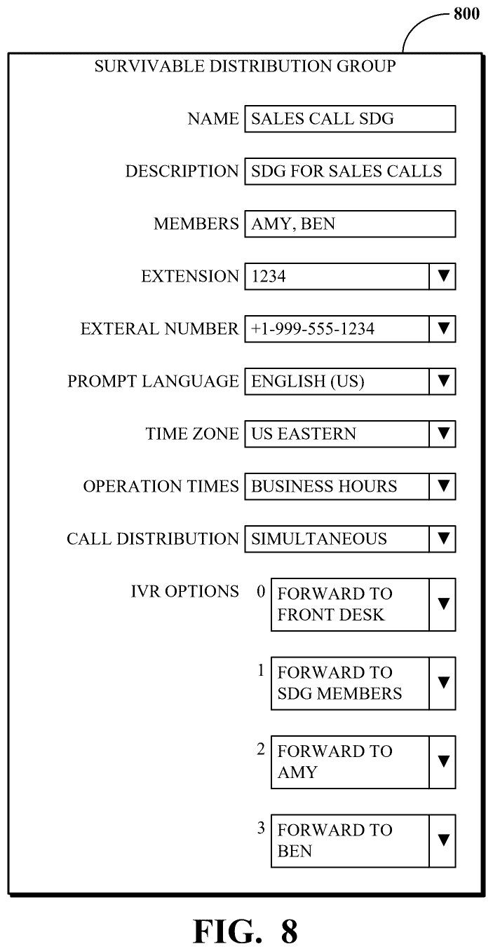

FIG. 8 illustrates a graphical user interface (GUI) 800 for creating or editing an SDG. The SDG may be used in telephony services, such as CQ or SLG. The GUI 800 may be presented at an administrator device or a client computing device associated with the premises. The administrator device or the client computing device may correspond to one of the clients 104A-D

As shown, the GUI includes input boxes for a name, a description, and members of the SDG. The GUI 800 includes dropdowns for selecting an extension, an external number, a prompt language, a time zone, an operation time, a call distribution, and IVR options for various IVR entries. The operation times specify times when the SDG is operational. As shown, the operation times are business hours. Alternative operation times may be custom (e.g., entered by the user) or always (e.g., 24 hours per day, 7 days per week). The call distribution may be simultaneous (e.g., for SLG, as illustrated) or serial (e.g., for CQ). As shown, there are four IVR options (for entries 0 through 3). In alternative implementations, there may be a different number of IVR options.

The GUI 800 may be used to generate stored data associated with the network-based telephony services. The stored data may be stored at the telephony server 506 and may be periodically downloaded by the on-premises SBC 512 and/or the on-premises telephony node 514 for storage thereat. Storage of the stored data at the on-premises SBC 512 and/or the on-premises telephony node 514 may allow for provision of the telephony services when the telephony server 506 is inaccessible, unavailable, or overloaded.

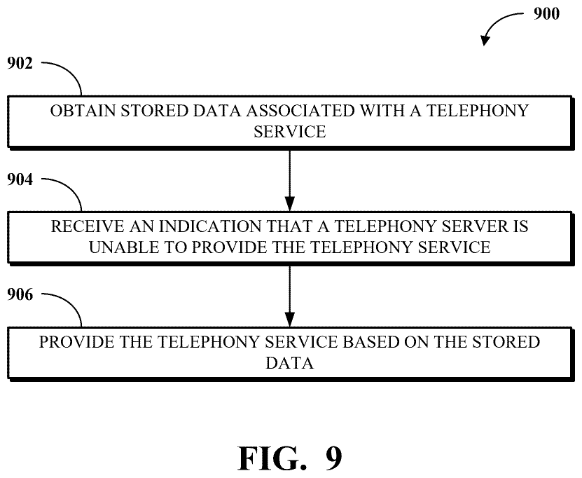

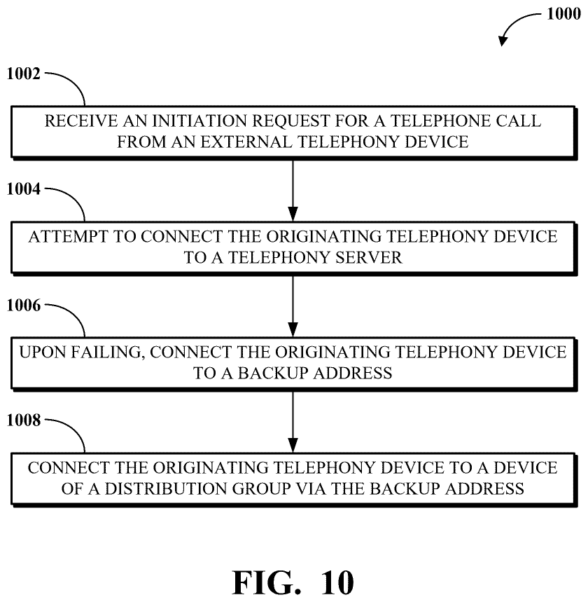

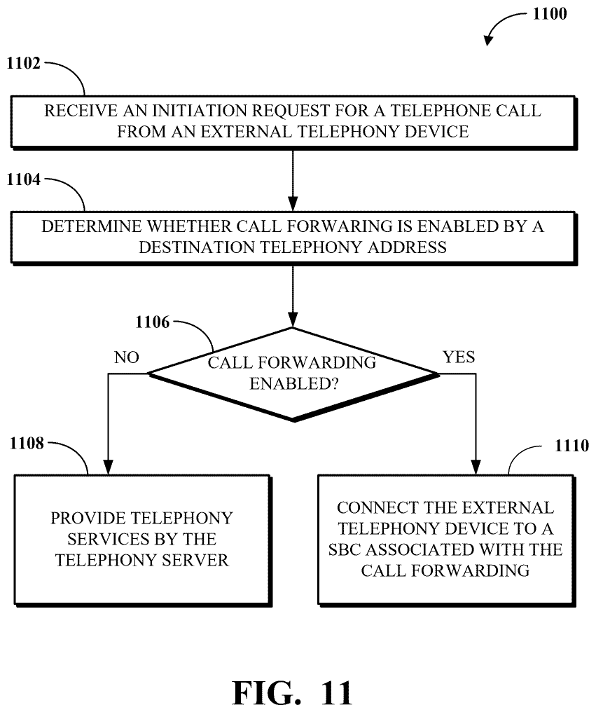

To further describe some implementations in greater detail, reference is next made to examples of techniques which may be performed by or using a system for providing on-premises telephony services. FIG. 9 is a flowchart of an example of a technique 900 for providing telephony services at an on-premises telephony node. FIG. 10 is a flowchart of an example of a technique 1000 for routing to a survivable distribution group. FIG. 11 is a flowchart of an example of a technique 1100 for providing telephony services using a telephony server or an on-premises session border controller. The techniques 900, 1000, and/or 1100 can be executed using computing devices, such as the systems, hardware, and software described with respect to FIGS. 1-8. The techniques 900, 1000, and/or 1100 can be performed, for example, by executing a machine-readable program or other computer-executable instructions, such as routines, instructions, programs, or other code. The steps, or operations, of the techniques 900, 1000, 1100, or another technique, method, process, or algorithm described in connection with the implementations disclosed herein can be implemented directly in hardware, firmware, software executed by hardware, circuitry, or a combination thereof.

For simplicity of explanation, the techniques 900, 1000, and 1100 are depicted and described herein as series of steps or operations. However, the steps or operations of the techniques 900, 1000, and/or 1100 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

FIG. 9 illustrates the technique 900 for providing telephony services at an on-premises telephony node.

At 902, an on-premises telephony node (e.g., the on-premises telephony node 514) of a premises (e.g., the premises 510) where telephony services are accessed obtains, from a telephony server, (e.g., the telephony server 506) stored data associated with a network-based telephony service. The network-based telephony service includes at least one of an automated receptionist service, a CQ service, or a SLG service. The network-based telephony service may be a SDG-based service.

At 904, the on-premises telephony node receives an indication that the telephony server is unable to provide the network-based telephony service. The telephony server may be unable to provide the network-based telephony service due to at least one of (i) the telephony server being unavailable or having too much latency or (ii) a network connection of the premises to the telephony server being unavailable or being available below a threshold speed. In some cases, the on-premises telephony node receives (e.g., from an administrator device of the premises) a notification that the telephony server is unable to provide the network-based telephony service. In some cases, the on-premises telephony node receives the indication that the telephony server is unable to provide the network-based telephony service by transmitting a ping request or an echo request to the telephony server, and failing to receive a ping response or an echo response within a threshold time.

At 906, the on-premises telephony node provides the network-based telephony service based on the stored data. The on-premises telephony node may configure itself and/or other hardware of the premises to provide the network-based telephony service. As a result, the network-based telephony service may be provided during network outages or telephony server outages, providing a better user experience to the users of the telephony services.

FIG. 10 illustrates the technique 1000 for routing to a survivable distribution group.

At 1002, an SBC (e.g., the network-based SBC 604) receives an initiation request for a telephone call from an originating telephony device (e.g., the caller device 602) to a destination telephony address. The initiation request may occur in response to a user of the originating telephony device dialing a telephone number (corresponding to the destination telephony address) associated with the SBC. The SBC is separate and distinct from a telephony server (e.g., the telephony server 606) associated with the destination telephony address that provides (or is configured to provide) telephony services for the destination telephony address.

At 1004, the SBC attempts to connect the originating telephony device to the telephony server for processing the initiation request. In some cases, the SBC successfully connects to the telephony server, and the telephony server handles the initiation request. For example, the telephony server may identify a distribution group associated with the initiation request (e.g., based on the destination telephony address). The telephony server may case devices (e.g., one or more of the internal telephony devices 610) of the distribution group to ring or otherwise indicate the initiation of the telephone call, as specified by the distribution group. For example, in CQ, the devices may ring sequentially. In SLG, the devices may ring in parallel. In some cases, the SBC fails to connect to the telephony server, for example, due to an outage of the telephony server or excessive (e.g., exceeding a threshold response time) latency of the telephony server. Upon failure to connect to the telephony server, the technique 1000 continues to 1006.

In some cases, attempting to connect the originating telephony device to the telephony server includes transmitting an echo request (e.g., a ping request) to the telephony server. Failure to connect the originating telephony device to the telephony server includes failing to receive an echo response (e.g., a ping response) from the telephony server during a threshold time period (e.g., one second or two seconds) after transmitting the echo request. The echo request and/or the echo response may include a single packet or multiple packets.

At 1006, upon failing to connect the originating telephony device to the telephony server, the SBC connects the originating telephony device to a backup address associated with a distribution group. The distribution group is identified based on the destination telephony address. The backup address may be stored at the SBC or at a data repository (e.g., a database or another type of data store) accessible to the SBC. For example, the SBC or the data repository may store a table (or another data structure) mapping destination telephony addresses to backup addresses, with the destination telephony address of the initiation request being mapped to the backup address to which the SBC connects the originating telephony device. If the storage is in the data repository, the SBC accesses the data repository. In some cases, the backup address corresponds to the on-premises telephony node (e.g., the on-premises telephony node 608) of a premises associated with the destination telephony address or the distribution group.

At 1008, the SBC causes connection of the telephony device to a device of the distribution group via the backup address. The connection itself may be made by the SBC or by on-premises telephony hardware (e.g., the on-premises telephony node 608). The connection may occur based on specifications of the distribution group, which may be a survivable distribution group. The distribution group may specify whether the devices of the distribution group are to be accessed in series, in parallel, or using another ordering technique (e.g., some in parallel, and others in series if the first group of devices are not answered). The devices of the distribution group may be located within a premises associated with the backup address.

FIG. 11 illustrates the technique 1100 for providing telephony services using a telephony server or an on-premises session border controller.

At 1102, a telephony server (e.g., the telephony server 704) receives an initiation request for a telephone call from an external telephony device (e.g., the caller device 702). The initiation request may occur in response to a user of the originating telephony device dialing a telephone number associated with the telephony server.

At 1104, the telephony server determines whether call forwarding is enabled by a destination telephony address of the telephone call. The destination telephony address corresponds to the telephone number. The telephony server may determine whether the call forwarding is enabled by accessing a data structure (e.g., the call forward status 706) in a memory subsystem of the telephony server. The data structure may include at least one of an array, a matrix, a table, or another type of data structure.

At 1106, if call forwarding is enabled, the technique 1100 continues to 1108. If call forwarding is not enabled, the technique 1100 continues to 1110.

At 1108, based on determining that the call forwarding is not enabled, the telephony server provides telephony services for the telephone call.

At 1110, based on determining that the call forwarding is enabled, the telephony server connects the external telephony device to an SBC (e.g., the on-premises SBC 708) associated with the call forwarding. The SBC provides the telephony services for the telephone call. A telephony address of the SBC may be specified in the data structure. In some cases, the SBC includes an on-premises telephony node.

In some implementations, the telephony server enables the call forwarding in response to a load of the telephony server exceeding a threshold load. In some cases, the telephony server enables the call forwarding based on a request from an administrator device (or another client computing device) associated with the premises or the SBC. In some implementations, call forwarding is enabled in response to a telephony outage at a premises of the SBC. The telephony server may periodically attempt to connect to the premises or to the SBC and may automatically enable the call forwarding upon failing to connect to the premises or to the SBC.

Some implementations are described below as numbered examples (Example 1, 2, 3, etc.). These examples are provided as examples only and do not limit the other implementations disclosed herein.
Example 1 is a method, comprising: obtaining, by an on-premises telephony node of a premises where telephony services are accessed and from a telephony server, stored data associated with a network-based telephony service, the network-based telephony service including at least one of an automated receptionist service, a call queue service, or a shared line group service; receiving, by the on-premises telephony node, an indication that the telephony server is unable to provide the network-based telephony service; and providing, by the on-premises telephony node and in response to the indication, the network-based telephony service based on the stored data.
In Example 2, the subject matter of Example 1 includes, prompting, at a predefined interval and prior to receiving the indication, the telephony server to transmit updates to the stored data to the on-premises telephony node; and receiving, by the telephony node, the updates to the stored data.
In Example 3, the subject matter of Examples 1-2 includes, wherein receiving the indication that the telephony server is unable to provide the network-based telephony service comprises: receiving the indication from an administrator device of the premises.
In Example 4, the subject matter of Examples 1-3 includes, wherein receiving the indication that the telephony server is unable to provide the network-based telephony service comprises: transmitting a ping request to the telephony server; and failing to receive a ping response within a threshold time.
In Example 5, the subject matter of Examples 1-4 includes, wherein the shared line group service enables access to a telephone line from multiple computing devices associated with multiple user accounts, wherein an incoming call to a telephone number of the shared line group causes parallel or simultaneous ringing of the multiple computing devices.
In Example 6, the subject matter of Examples 1-5 includes, wherein the call queue service enables serially routing an incoming call to multiple users according to a stored call queue data structure.
In Example 7, the subject matter of Examples 1-6 includes, wherein the automated receptionist service enables, in response to an incoming call, playing a greeting and providing a menu for routing the incoming call to a user-selected destination.
Example 8 is a non-transitory computer readable medium storing instructions operable to cause one or more processors to perform operations comprising: obtaining, by an on-premises telephony node of a premises where telephony services are accessed and from a telephony server, stored data associated with a network-based telephony service, the network-based telephony service including at least one of an automated receptionist service, a call queue service, or a shared line group service; receiving, by the on-premises telephony node, an indication that the telephony server is unable to provide the network-based telephony service; and providing, by the on-premises telephony node and in response to the indication, the network-based telephony service based on the stored data.
In Example 9, the subject matter of Example 8 includes, the operations comprising: prompting, prior to receiving the indication, the telephony server to transmit updates to the stored data to the on-premises telephony node; and receiving, by the telephony node, the updates to the stored data.
In Example 10, the subject matter of Examples 8-9 includes, wherein receiving the indication that the telephony server is unable to provide the network-based telephony service comprises: receiving the indication from a client device of the premises.
In Example 11, the subject matter of Examples 8-10 includes, wherein receiving the indication that the telephony server is unable to provide the network-based telephony service comprises: transmitting an echo request to the telephony server; and failing to receive an echo response within a threshold time.
In Example 12, the subject matter of Examples 8-11 includes, wherein the shared line group service enables access to a telephone line from multiple user accounts, wherein an incoming call to a telephone number of the shared line group causes parallel or simultaneous ringing of multiple computing devices of the multiple user accounts.
In Example 13, the subject matter of Examples 8-12 includes, wherein the call queue service enables serially routing an incoming call to multiple telephony devices.
In Example 14, the subject matter of Examples 8-13 includes, wherein the automated receptionist service enables, in response to an incoming call, providing a menu for routing the incoming call to a user-selected destination.
Example 15 is a system, comprising: a memory subsystem storing instructions; and processing circuitry configured to execute the instructions to: obtain, by an on-premises telephony node of a premises where telephony services are accessed and from a telephony server, stored data associated with a network-based telephony service, the network-based telephony service including at least one of an automated receptionist service, a call queue service, or a shared line group service; receive, by the on-premises telephony node, an indication that the telephony server is unable to provide the network-based telephony service; and provide, by the on-premises telephony node and in response to the indication, the network-based telephony service based on the stored data.
In Example 16, the subject matter of Example 15 includes, the processing circuitry further configured to execute the instructions to: prompt, at a predefined interval, the telephony server to transmit updates to the stored data to the on-premises telephony node; and receive, by the telephony node, the updates to the stored data.
In Example 17, the subject matter of Examples 15-16 includes, wherein receiving the indication that the telephony server is unable to provide the network-based telephony service comprises: receiving the indication from a device of the premises.
In Example 18, the subject matter of Examples 15-17 includes, wherein receiving the indication that the telephony server is unable to provide the network-based telephony service comprises: transmitting a request to the telephony server; and failing to receive a response to the request within a threshold time.
In Example 19, the subject matter of Examples 15-18 includes, wherein the shared line group service enables access to a telephone line from multiple telephony devices associated with multiple user accounts, wherein an incoming call to a telephone number of the shared line group causes parallel or simultaneous ringing of the multiple telephony devices.
In Example 20, the subject matter of Examples 15-19 includes, wherein the automated receptionist service enables, in response to an incoming call, playing a greeting and providing an interactive voice response menu for routing the incoming call.
Example 21 is a method comprising: receiving, by a session border controller that is separate from a telephony server associated with a destination telephony address, an initiation request for a telephone call from an originating telephony device to the destination telephony address; attempting to connect the originating telephony device to the telephony server; upon failing to connect the originating telephony device to the telephony server, connecting the originating telephony device to a backup address associated with a distribution group; and causing connection of the telephony device to a device of the distribution group via the backup address.
In Example 22, the subject matter of Example 21 includes, wherein the backup address corresponds to an on-premises telephony node of a premises associated with the distribution group.
In Example 23, the subject matter of Examples 21-22 includes, wherein the distribution group comprises a survivable distribution group.
In Example 24, the subject matter of Examples 21-23 includes, identifying the distribution group based on the destination telephony address.
In Example 25, the subject matter of Examples 21-24 includes, wherein attempting to connect the originating telephony device to the telephony server comprises: transmitting an echo request to the telephony server.
In Example 26, the subject matter of Examples 21-25 includes, wherein failing to connect the originating telephony device to the telephony server comprises: failing to receive an echo response from the telephony server during a threshold time period.
In Example 27, the subject matter of Examples 21-26 includes, wherein the device of the distribution group is located within a premises associated with the backup address.
In Example 28, the subject matter of Examples 21-27 includes, upon failing to connect the originating telephony device to the telephony server, accessing a data repository to identify the backup address.
Example 29 is a non-transitory computer readable medium storing instructions operable to cause one or more processors to perform operations comprising: receiving, by a session border controller that is separate from a telephony server associated with a destination telephony address, an initiation request for a telephone call from an originating telephony device to the destination telephony address; attempting to connect the originating telephony device to the telephony server; upon failing to connect the originating telephony device to the telephony server, connecting the originating telephony device to a backup address associated with a distribution group; and causing connection of the telephony device to a device of the distribution group via the backup address.
In Example 30, the subject matter of Example 29 includes, wherein the backup address corresponds to an on-premises node of a premises associated with the distribution group.
In Example 31, the subject matter of Examples 29-30 includes, wherein the distribution group comprises a survivable distribution group capable of surviving an outage of the telephony server.
In Example 32, the subject matter of Examples 29-31 includes, the operations comprising: identifying the distribution group based on the initiation request.
In Example 33, the subject matter of Examples 29-32 includes, wherein attempting to connect the originating telephony device to the telephony server comprises: transmitting a ping request to the telephony server.
In Example 34, the subject matter of Examples 29-33 includes, wherein failing to connect the originating telephony device to the telephony server comprises: failing to receive a ping response from the telephony server during a threshold time period.
In Example 35, the subject matter of Examples 29-34 includes, wherein the device of the distribution group is located within a premises of the backup address.
In Example 36, the subject matter of Examples 29-35 includes, the operations comprising: upon failing to connect the originating telephony device to the telephony server, accessing a database to identify the backup address.
Example 37 is a system, comprising: a memory subsystem storing instructions; and processing circuitry configured to execute the instructions to: receive, by a session border controller that is separate from a telephony server associated with a destination telephony address, an initiation request for a telephone call from an originating telephony device to the destination telephony address; attempt to connect the originating telephony device to a telephony server associated with the destination telephony address; upon failing to connect the originating telephony device to the telephony server, connect the originating telephony device to a backup address associated with a survivable distribution group; and cause connection of the telephony device to a device of the survivable distribution group via the backup address.
In Example 38, the subject matter of Example 37 includes, wherein attempting to connect the originating telephony device to the telephony server comprises: transmitting an echo request packet to the telephony server.
In Example 39, the subject matter of Examples 37-38 includes, wherein failing to connect the originating telephony device to the telephony server comprises: failing to receive an echo response packet from the telephony server during a threshold time period.
In Example 40, the subject matter of Examples 37-39 includes, the processing circuitry configured to execute the instructions to: upon failing to connect the originating telephony device to the telephony server, access a data store to identify the backup address.
Example 41 is a system comprising: a memory subsystem storing instructions; and processing circuitry configured to execute the instructions to: receive, by a telephony server providing telephony services to a destination telephony address, an initiation request for a telephone call from an external telephony device to the destination telephony address; determine, by the telephony server and based on a stored setting associated with the destination telephony address, whether call forwarding is enabled by the destination telephony address; and perform one of: based on determining that the call forwarding is not enabled: provide telephony services for the telephone call by the telephony server, the telephony services comprising at least one of an automated receptionist service, a call queue service, or a shared line group service; or based on determining that the call forwarding is enabled: connect the external telephony device to a session border controller associated with the call forwarding, the session border controller providing the telephony services for the telephone call.
In Example 42, the subject matter of Example 41 includes, the processing circuitry configured to execute the instructions to: enable the call forwarding in response to a load of the telephony server exceeding a threshold load.
In Example 43, the subject matter of Examples 41-42 includes, the processing circuitry configured to execute the instructions to: enabling the call forwarding based on a request from an administrator device associated with the session border controller.
In Example 44, the subject matter of Examples 41-43 includes, the processing circuitry configured to execute the instructions to: enable the call forwarding in response to a telephony outage at a premises of the session border controller.
In Example 45, the subject matter of Examples 41-44 includes, wherein the session border controller comprises an on-premises telephony node.
In Example 46, the subject matter of Examples 41-45 includes, wherein the shared line group service enables access to a telephone line from multiple computing devices associated with multiple user accounts, wherein an incoming call to a telephone number of the shared line group causes parallel or simultaneous ringing of the multiple computing devices.
In Example 47, the subject matter of Examples 41-46 includes, wherein the call queue service enables serially routing an incoming call to multiple user accounts according to a stored call queue data structure.
In Example 48, the subject matter of Examples 41-47 includes, wherein the automated receptionist service enables, in response to an incoming call, playing a greeting and providing a menu for routing the incoming call to a user-selected destination.
Example 49 is a non-transitory computer readable medium storing instructions operable to cause one or more processors to perform operations comprising: receiving, by a telephony server providing telephony services to a destination telephony address, an initiation request for a telephone call from an external telephony device to the destination telephony address; determining, by the telephony server and based on a stored setting associated with the destination telephony address, whether call forwarding is enabled by the destination telephony address; and performing one of: based on determining that the call forwarding is not enabled: providing telephony services for the telephone call by the telephony server, the telephony services comprising at least one of an automated receptionist service, a call queue service, or a shared line group service; or based on determining that the call forwarding is enabled: connecting the external telephony device to a session border controller associated with the call forwarding, the session border controller providing the telephony services for the telephone call.
In Example 50, the subject matter of Example 49 includes, the operations comprising: enabling the call forwarding in response to a load of the telephony server being within a range.
In Example 51, the subject matter of Examples 49-50 includes, the operations comprising: enabling the call forwarding based on a request from an administrator device associated with a premises of the session border controller.
In Example 52, the subject matter of Examples 49-51 includes, the operations comprising: enabling the call forwarding in response to a telephony outage.
In Example 53, the subject matter of Examples 49-52 includes, wherein an on-premises telephony node comprises the session border controller.
In Example 54, the subject matter of Examples 49-53 includes, wherein the shared line group service enables access to a telephone line from multiple user accounts, wherein an incoming call to a telephone number of the shared line group causes parallel or simultaneous ringing of multiple computing devices of the multiple user accounts.
In Example 55, the subject matter of Examples 49-54 includes, wherein the call queue service enables serially routing an incoming call to multiple devices according to a stored call queue data structure.
In Example 56, the subject matter of Examples 49-55 includes, wherein the automated receptionist service enables, in response to an incoming call, playing a greeting and providing an interactive voice response menu for routing the incoming call to a user-selected destination.
Example 57 is an apparatus comprising: memory hardware storing instructions; and processing hardware configure to execute the instructions to: receive, by a telephony server providing telephony services to a destination telephony address, an initiation request for a telephone call from an external telephony device to the destination telephony address; determine, by the telephony server and based on a stored setting associated with the destination telephony address, whether call forwarding is enabled by the destination telephony address; and perform one of: based on determining that the call forwarding is not enabled: provide telephony services for the telephone call by the telephony server, the telephony services comprising at least one of an automated receptionist service, a call queue service, or a shared line group service; or based on determining that the call forwarding is enabled: connect the external telephony device to a session border controller associated with the call forwarding, the session border controller providing the telephony services for the telephone call.
In Example 58, the subject matter of Example 57 includes, the processing hardware configured to execute the instructions to: enable the call forwarding based on a load of the telephony server.
In Example 59, the subject matter of Examples 57-58 includes, the processing hardware configured to execute the instructions to: enable the call forwarding based on a request from an administrator device.
In Example 60, the subject matter of Examples 57-59 includes, the processing hardware configured to execute the instructions to: enable the call forwarding in response to a network outage.
Example 61 is at least one machine-readable medium including instructions that, when executed by processing circuitry, cause the processing circuitry to perform operations to implement of any of Examples 1-60.
Example 62 is an apparatus comprising means to implement of any of Examples 1-60.
Example 63 is a system to implement of any of Examples 1-60.
Example 64 is a method to implement of any of Examples 1-60.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

As used herein, the term “and/or” encompasses its plain and ordinary meaning and may refer to an intersection or a union of sets of data. For example, the phrase “A and/or B” encompasses the union of A and B. The phrase “A and/or B” encompasses the intersection of A and B.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A system comprising:
a memory subsystem storing instructions; and
processing circuitry configured to execute the instructions to:
receive, by a telephony server providing telephony services to a destination telephony address, an initiation request for a telephone call from an external telephony device to the destination telephony address;
determine, by the telephony server and based on a stored setting associated with the destination telephony address, whether call forwarding is enabled by the destination telephony address; and
perform one of:
based on determining that the call forwarding is not enabled: provide telephony services for the telephone call by the telephony server, the telephony services comprising at least one of an automated receptionist service, a call queue service, or a shared line group service; or
based on determining that the call forwarding is enabled: connect the external telephony device to a session border controller associated with the call forwarding, the session border controller providing the telephony services for the telephone call.

2. The system of claim 1, the processing circuitry configured to execute the instructions to:
enable the call forwarding in response to a load of the telephony server exceeding a threshold load.

3. The system of claim 1, the processing circuitry configured to execute the instructions to:
enabling the call forwarding based on a request from an administrator device associated with the session border controller.

4. The system of claim 1, the processing circuitry configured to execute the instructions to:
enable the call forwarding in response to a telephony outage at a premises of the session border controller.

5. The system of claim 1, wherein the session border controller comprises an on-premises telephony node.

6. The system of claim 1, wherein the shared line group service enables access to a telephone line from multiple computing devices associated with multiple user accounts, wherein an incoming call to a telephone number of the shared line group causes parallel or simultaneous ringing of the multiple computing devices.

7. The system of claim 1, wherein the call queue service enables serially routing an incoming call to multiple user accounts according to a stored call queue data structure.

8. The system of claim 1, wherein the automated receptionist service enables, in response to an incoming call, playing a greeting and providing a menu for routing the incoming call to a user-selected destination.

9. A non-transitory computer readable medium storing instructions operable to cause one or more processors to perform operations comprising:
receiving, by a telephony server providing telephony services to a destination telephony address, an initiation request for a telephone call from an external telephony device to the destination telephony address;
determining, by the telephony server and based on a stored setting associated with the destination telephony address, whether call forwarding is enabled by the destination telephony address; and
performing one of:
based on determining that the call forwarding is not enabled: providing telephony services for the telephone call by the telephony server, the telephony services comprising at least one of an automated receptionist service, a call queue service, or a shared line group service; or
based on determining that the call forwarding is enabled: connecting the external telephony device to a session border controller associated with the call forwarding, the session border controller providing the telephony services for the telephone call.

10. The non-transitory computer readable medium of claim 9, the operations comprising:
enabling the call forwarding in response to a load of the telephony server being within a range.

11. The non-transitory computer readable medium of claim 9, the operations comprising:
enabling the call forwarding based on a request from an administrator device associated with a premises of the session border controller.

12. The non-transitory computer readable medium of claim 9, the operations comprising:
enabling the call forwarding in response to a telephony outage.

13. The non-transitory computer readable medium of claim 9, wherein an on-premises telephony node comprises the session border controller.

14. The non-transitory computer readable medium of claim 9, wherein the shared line group service enables access to a telephone line from multiple user accounts, wherein an incoming call to a telephone number of the shared line group causes parallel or simultaneous ringing of multiple computing devices of the multiple user accounts.

15. The non-transitory computer readable medium of claim 9, wherein the call queue service enables serially routing an incoming call to multiple devices according to a stored call queue data structure.

16. The non-transitory computer readable medium of claim 9, wherein the automated receptionist service enables, in response to an incoming call, playing a greeting and providing an interactive voice response menu for routing the incoming call to a user-selected destination.

17. An apparatus comprising:
memory hardware storing instructions; and
processing hardware configured to execute the instructions to:
receive, by a telephony server providing telephony services to a destination telephony address, an initiation request for a telephone call from an external telephony device to the destination telephony address;
determine, by the telephony server and based on a stored setting associated with the destination telephony address, whether call forwarding is enabled by the destination telephony address; and
perform one of:
based on determining that the call forwarding is not enabled: provide telephony services for the telephone call by the telephony server, the telephony services comprising at least one of an automated receptionist service, a call queue service, or a shared line group service; or
based on determining that the call forwarding is enabled: connect the external telephony device to a session border controller associated with the call forwarding, the session border controller providing the telephony services for the telephone call.

18. The apparatus of claim 17, the processing hardware configured to execute the instructions to:
enable the call forwarding based on a load of the telephony server.

19. The apparatus of claim 17, the processing hardware configured to execute the instructions to:
enable the call forwarding based on a request from an administrator device.

20. The apparatus of claim 17, the processing hardware configured to execute the instructions to:
enable the call forwarding in response to a network outage.
